(19) United States
(12) Patent Application Publication
(10) Pub. No.: US 2022/0382987 A1
(43) Pub. Date: Dec. 1, 2022

(54) DETERMINING SENTIMENTS OF SENTENCES OF A GROUP OF SENTENCES

(71) Applicant: WIZER FEEDBACK LTD., Caesarea (IL)

(72) Inventors: ELI KATZ, Tel Aviv (IL); Alon Ravid, Haifa (IL)

(73) Assignee: WIZER FEEDBACK LTD., Caesarea (IL)

(21) Appl. No.: 17/303,501

(22) Filed: May 31, 2021

(51) Int. Cl. G06F 40/30; G06F 40/289

(52) U.S. Cl. CPC G06F 40/30; G06F 40/289

(57) ABSTRACT

A method for determining sentiments of sentences of a group of sentences, the method may include (a) obtaining the group of sentences; (b) finding, within the group of sentences, one or more sets of linked sentences; wherein each set of the one or more sets comprises sentences that are linked to each other by one or more sentence linking elements, wherein a sentence linking element comprises at least one out of a verb flow, a noun flow, and an endophora; and (c) calculating a sentiment of a certain sentence of a set of the one or more sets based on, at least, a sentiment of at least one other sentence of the set.

### BACKGROUND

Sentiment analysis (also known as opinion mining or emotion AI) is the use of natural language processing, text analysis, computational linguistics, and biometrics to systematically identify, extract, quantify, and study affective states and subjective information. Sentiment analysis is widely applied to voice of the customer materials such as reviews and survey responses, online and social media, and healthcare materials for applications that range from marketing to customer service to clinical medicine. (see: www.wikipedia.org)

Significant computing resources are allocated to sentiment analysis.

Sentiment analysis is made on a sentence based—wherein the sentiment of each sentence is made based solely on the content of the sentence.

The sentence based sentiment analysis may be inaccurate and there is a need to increase the accuracy of the sentiment analysis.

### SUMMARY

There may be provided a storage system, a method and a non-transitory computer readable medium for determining sentiments of sentences of a group of sentences.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates an example of a method;

FIG. 2 illustrates an example of data structures;

FIG. 3 illustrates an example of a computerized system and its environment.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organ ization and method of operation, together with objects, features, and advantages thereof, may best be understood by reference to the following detailed description when read with the accompany ing drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a compute core . The compute core can be a processing circuitry, a part of processing circuitry, a virtual machine core, and the like. The processing circuitry may be implemented as a central processing unit (CPU), a graphic processing circuitry (GPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There is provided a system, a method and a non-transitory computer readable medium for determining sentiments of sentences of a group of sentences.

The system, method, and non-transitory computer readable medium are highly accurate and the accuracy is obtained as a very low computational cost. The low computational cost allows to analyze groups of sentences in real time (less than 0.01, 0.1, 0.5, 1 second or a few seconds, and the like).

The system, method, and non-transitory computer readable medium enables an accurate determining sentiments of sentences of a multiple groups of sentences in real time.

The group of sentences may belong to one or more documents, may belong to one or more paragraphs, and the like.

The method may include finding, within the group of sentences, one or more sets of linked sentences. Thus in a certain group of sentences there may be any number of sentences that exceeds one.

Each set of the one or more sets includes sentences that are linked to each other by one or more sentence linking elements.

A sentence linking element may be at least one out of a verb flow, a noun flow, and an endophora. The endophora may be an anaphora or a cataphora.

For example—a sentence linking element may be two or more out of a verb flow, a noun flow, and an endophora.

Yet for example—a sentence linking element may be a noun flow or an endophora.

Different sentences may be linked by different sentence linking elements. For example two sentences may be linked by a noun flow, and two other sentences may be linked by an endophora.

The method may include calculating the sentiment of one sentence, some sentences or all sentences of one, some or all sets of the one or more sets.

Relating to a set of sentences—the sentiment of a certain sentence may be calculated based on an initial sentiment of the certain sentence (calculated based on—or solely based on) the content of the sentence and based on the sentiments of one, some or all other sentences of the set.

Any function may be applied on the initial sentiment and sentiments of the one, some or all other sentences of the set. For example—the function may be an average, a weighted sum, a selection of the sentiment of one or more significant sentiment sentences of the set, and the like. Significant may be based on the difference between the sentiment and an inert sentence.

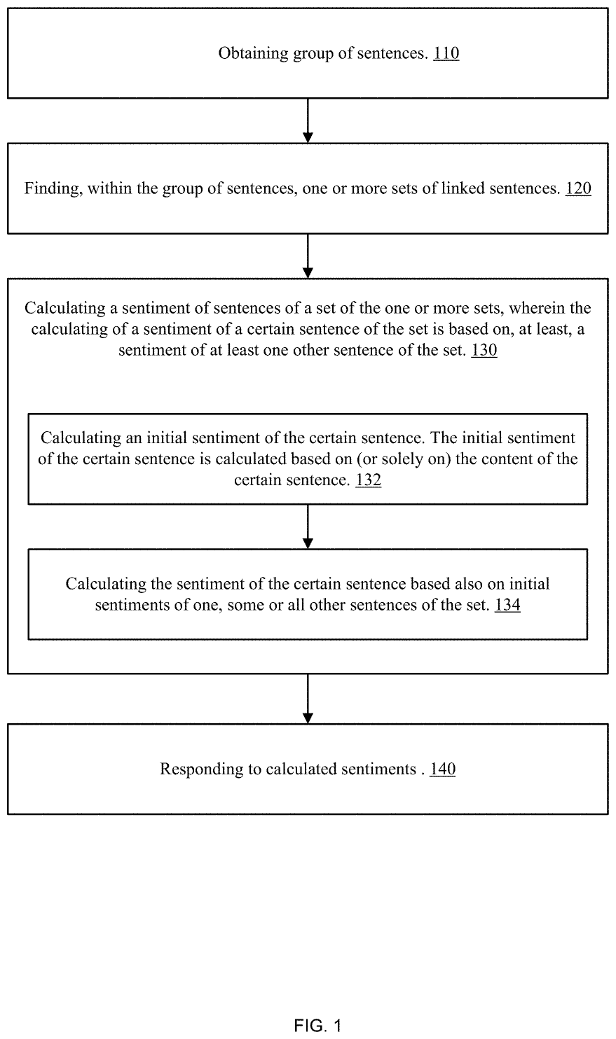

FIG. 1 illustrates method 100 for determining sentiments of sentences of a group of sentences.

Method 100 may start by step 110 of obtaining the group of sentences.

This may include receiving the group of sentences, retrieving the group of sentences, accessing a remote memory to receive the group of sentences, receiving one or more documents that include the group of sentences, and the like.

Step 110 may be followed by step 120 of finding, within the group of sentences, one or more sets of linked sentences.

A set may include a single sentence.

Usually, each set of the one or more sets may include sentences that are linked to each other by one or more sentence linking elements. A sentence linking element may include at least one out of a verb flow, a noun flow, and an endophora.

Step 120 may be followed by step 130 of calculating a sentiment of sentences of a set of the one or more sets, wherein the calculating of a sentiment of a certain sentence of the set is based on, at least, a sentiment of at least one other sentence of the set.

Step 130 may include step 132 of calculating an initial sentiment of the certain sentence. The initial sentiment of the certain sentence is calculated based on (or solely on) the content of the certain sentence.

Step 130 may also be include step 134 (that may follow step 132) of calculating the sentiment of the certain sentence based also on initial sentiments of one, some or all other sentences of the set.

Step 130 may include calculating sentiments of one, some or all sentences of one, some or all of the one or more sets.

An example of calculating the sentiment is provided below.
a. SAinit=an initial sentiment score of each sentence of a set.
b. VF=the verb flow score—for example the order of a tense of a verb in an ordered list of tenses.
c. VFmin=the lowest verb flow score in the set.

Assuming a sentence has a score that exceeds VFmin- then SAinit may be amplified based on the relationship between VF (of the sentence) and VFmin—for example SA may be amplified by VF/VFmin.

Yet for another example—assuming that ΔVF=VF−VFmin.

If ΔVF exceeds zero then the updated score SA=SAinit*VF/VFmin*(ΔVF/C1+1), C being a coefficient having a value that may be set in any manner—for example C may range between 10 to 100, between 20 to 80, between 30 and 70, and the like.

Yet for another example—assuming that there are K sentences in a set and their initial scores are SAinit(1)-SAinit(K), and have verb flow scores of VF(1)-VF(K). The verb flow scores may differ from VFmin by ΔVF(1)—ΔVF(K), and for each value of k (k ranges between 1 and K) their initial scores may be updated based on any selection function of SAinit(k) and at least one of VF(k) and ΔVF(k).

The score on one or more sentences of the set may be affected by one or more score of one or more other sentences of the set.

For example—the score of all sentences of the set may be the same—and may equal to a so called set score (set sentiment). The set sentiment may be a function of any of the amended or initial scores of any of the sentences of the set.

For example—the set score may be equal to an average, weighted sum or any other function of at least some of SA(1)-SA(K).

Because a sentiment of one sentence may be affected by one or more scores of one or more other sentences in the set—an initial inert sentence may become a sentence with positive or negative sentiment.

The method may include preventing the score of an initial inert sentence to cause an initially non-inert sentence to become an inert sentence by applying any rule.

Step 130 may be followed by step 140 of responding to calculated sentiments—for example storing the sentiments, displaying information about the sentiments, associating the calculated sentiments with the group of sentences, transmitting the calculated sentences, and the like.

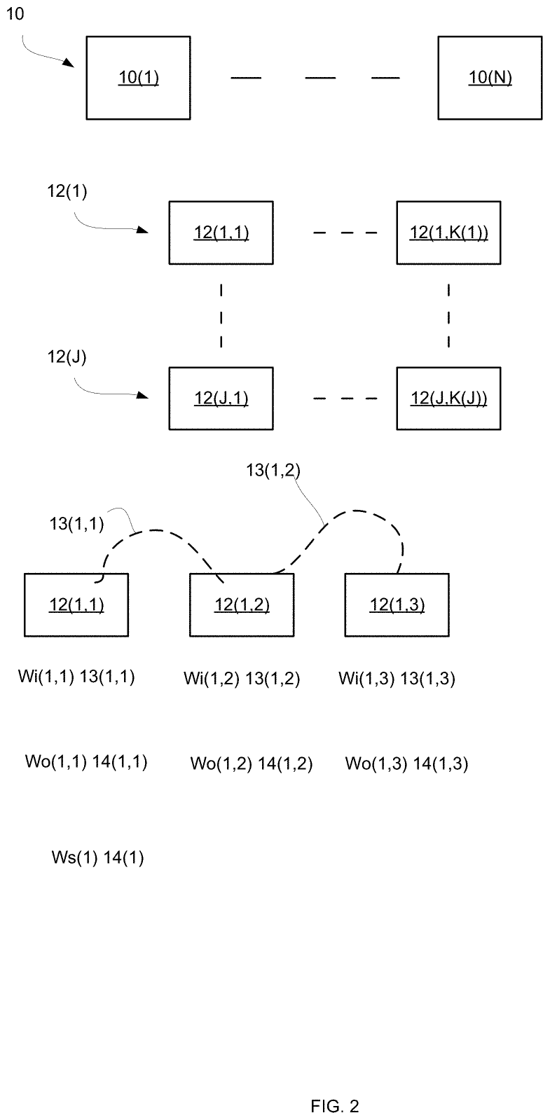

FIG. 2 is an example of various data elements such as a group 10 of sentences 10(1)-10(N) that include J sets of linked sentences—12(1)-12(J), having K(1) till K(J) sentences each respectively.

FIG. 2 also illustrates three sentences 12(1,1), 12(1,12) and 12(1,3) of set 12(1) linked by sentence linking elements 13(1,1) and 13(1,2) respectively.

The three sentences 12(1,1), 12(1,12) and 12(1,3) may include three initial sentiment weights Wi(1,1)—Wi(1,3) 13(1,1)—13(1,3) respectively. Following the execution of method 100 may include calculated or output sentiment weights Wo(1,1)—Wo(1,3) 14(1,1)—14(1,3) respectively.

At least one of the output sentiment weight of one of the sentences may be calculated based at least on the sentiment weight of another sentence of the set. For example—Wi(1,2) may be indicative that the second sentence is inert. Wo(1,2) may be calculated at least based on a sentiment of the first and/or third sentence (and/or based on the sentiment of the entire set) and may indicate that the sentiment of the second sentence is not inert.

Yet for another example—the first set may be assigned with a set weight Wd(1) 14(1)—that may be calculated by method 100.

Any reference to 12(1,1) should be applied to any other sentence of any set.

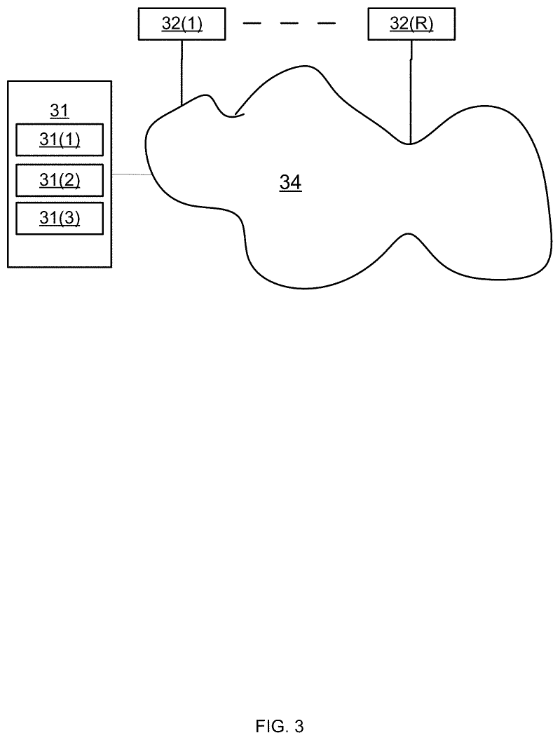

FIG. 3 illustrates an example of a computerized system 31 that is configured to execute method 100. It includes one or more processing circuits 31(1), memory 31(2) and communication unit 31(3). The computerized system 31 may communicate with one or more other computers 31(1)-32(R) over one or more networks 34. The one or more other computers 31(1)-32(R) may be the source of the group of sentences.

Various example of flows, scores and sentences are listed below.

Sentiment Direction vs. Score Versus Sentiment Score.

Sentiment score assumes the text is a static single unit that is comprised of lexical units (words), some of these units have a sentiment value. They are positive or negative by definition. The sentiment analysis algorithm takes the text as a whole and computes the overall score of the segment. This is true to all sentiment analysis algorithms common in the market today.

But is the text really a stationary, single chunk of text comprised of words ? Our research, and our patent assumes that is incorrect. The text is a flow. The same way a story is told, and as the story progresses there is a plot being built up, text has a “grammatical story” a flow of information that will influence the story. In fact, the method may break the text into segments, and analyze the connections, the verb and noun flows, we can place that information on a time series, and process it accordingly. As in time series, it is very relevant the order of things.

For example- given the following sentences:
a. I was sad before you came, now I am happy.
b. I was happy before you came, now I am sad.
c. I am sad now that you are here, before I was happy.
d. I am happy now that you are here, before I was sad.

If we look at the first two sentences, these two sentences are identical from the structure point of view, number of words, and the exact same adjectives that carry the sentiment value. If we calculate the sentiment based on the number of the words and locations, we reach the same score. Yet, it is quite obvious that the first sentence has a positive sentiment while the 2^{nd} sentence is clearly negative. The flow of the verb from past to present indicates that the direction of the flow is from left to right. The present will carry the important part of the message. So, it will be determined by the predicate I am Happy/Sad.

Noun Flow and Verb Flow

In the previous section we discussed the sentiment direction and demonstrated the Verb Flow. The flows are an essential particle of the method. The flow is a chain of verbs or nouns that occur in a discourse. Verb and noun flows are not interconnected. They are separated flows and indicates different things.

The Verb Flow—each sentence in the English has a verb of some structure. Verbs in the English language have sixteen tenses, which cover all possible time frames in language.

There tenses may be ordered according to the following order—past tenses, present tenses and future tenses.

The following example illustrate twelve of the sixteen tenses and their order (which represents their score):
a. The past tenses may be ordered according to the following order—past simple, past perfect, past continuous, and past perfect continuous.
b. The present tenses may be order according to the following order—present simple, present perfect, present continuous, and present perfect continuous.
c. The future tenses may be order according to the following order—future simple, future perfect, future continuous, and future perfect continuous.

This ordered list of tenses be used to explain the Verb Flow. Tenses in English grammar interact, much like time in a story. As the plot evolves, the story shares things that happened in the past, the then present unfolds while the future exist to deliver a promise or keep the tension. In grammar it is the same. When sentences are connected by being part of the same discourse, they will share a time line. Verbs that follow other verbs and keep the same tense indicates a list. Equal level sentences. Often the tense changes. As time progresses from the “farthest” past to the “farthest” future, the message is focusing, the weight of the information increases and therefore the sentiment on the focal point is stronger, it means more—it influences the sentiment value of the discourse.

“In a sense we've come to our nation's capital to cash a check. When the architects of our republic wrote the magnificent words of the Constitution and the Declaration of Independence, they were signing a promissory note to which every American was to fall heir”. This note was a promise that all men, yes, black men as well as white men, would be guaranteed the “unalienable Rights” of “Life, Liberty and the pursuit of Happiness.” It is obvious today that America has defaulted on this promissory note, insofar as her citizens of color are concerned. Instead of honoring this sacred obligation, America has given the Negro people a bad check, a check which has come back marked “insufficient funds.”—“I Have a Dream” speech, Martin Luther King, Jr.

Based on the method where we rank the verbs by their terms and based on that rank we “draw” the curve, the curve is going up in the sentence “they were signing a promissory note to which every American was to fall heir” because the verb here is not an action in the past that ended. It's a past continuous verb that persists till today. That was his message. That is also the grammatical structure. If we were to choose the sentences out of this section by their importance, this sentence would be in the top of the list.

The verb flows may have three functions:
a. The flow indicates connection between sentences. A change in the flow indicates a start of a new theme or paragraph. This function is also met by the Noun Flow.
b. The flow indicates which sentences are “higher” and therefore have to be considered more important when deciding the sentiment of the text.
c. The flow helps in deciding the sentiment of inert sentences by having a higher ranked sentence connected with calculatable sentiment.

The Noun Flow—

“Once upon a time there lived a poor widow and her son Jack. One day, Jack's mother told him to sell their only cow. Jack went to the market and on the way he met a man who wanted to buy his cow Jack asked, “What will you give me in return for my cow?” The man answered, “I will give you five magic beans!” Jack took the magic beans and gave the man the cow. But when he reached home, Jack's mother was very angry. She said, “You fool! He took away your cow and gave you some beans!” She threw the beans out of the window Jack was very sad and went to sleep without dinner.” From “Jack and the Beanstalk”

He met a man who wanted to buy his cow> . . . Jack took the magic beans and gave the man the cow

The Noun flow always travel from the least known noun to the most specific, known noun. In the least known , lowest rank we have the articles “a, an, NUMERALS (one, two)”. the second in the rank is the article “The”. The usage of this article indicates recognition. Either the noun was introduced in a previous sentence or there is an exophora (a reference to external knowledge, e.g. The president of the united states, even when not mentioned before in the text will be addressed with THE). The next rank is the demonstratives (Demonstratives pronouns)>THIS, THAT<THOSE<THESE. This is the highest familiarity a noun that is not a proper noun.

If a group of connected sentences refers to a specific noun, the flow will always be upward. It can remain in the same level but can never go down. A drop in the familiarity—noun flow rank—means that the noun affiliation has changed.

It looks the same but it refers to someone else:
a. I saw a boy in the yard. I talked to the boy. I hate this boy!
b. I saw a boy in the yard. I talked to the boy. I hate a boy!

In the second example the rank dropped. And the article “a” was used which will indicate that this is NOT the same boy from the first 2 sentences.

Anaphora (& Cataphora)

The Verb Flow and the noun flow often indicate the ties between sentences, meaning that they are of the same discourse unit. Anaphora does the same.

Anaphora, which means in Greek “reference”, is when a pronoun us used to reference a noun that was used before. Scientifically, Anaphora is the general name of reference. Cataphora, Anaphora and Exophora are members of this group. When we talk about Anaphora in this application we refer to Anaphora as a group member—anaphora that reference back. And not Anaphora—the general term for reference.

“Once upon a time there was a young boy named Tom. He lived in a tent by the river”
a. Tom=antecedent, the noun that is referenced.
b. He=anaphor, the pronoun that points back.

Cataphora is similar to anaphora, but the reference is forward:

“As soon as he arrived home, Tom went to sleep.”
a. He=cataphor, the pronoun that point forward.
b. Tom=postcedent, the pronoun that point forward.

The anaphora is more common in the language.

The anaphora serves 2 functions in the method:
a. To link sentences. Like the Flows, two sentences with anaphoric or cataphoric reference are connected, part of the same discourse which is the prerequisite for the method to calculate sentiment.
b. The reference indicates direction. Much like the flows and sentiment direction, the reference direction also indicates importance.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for determining sentiments of sentences of a group of sentences, the method comprising:
obtaining the group of sentences;
finding, within the group of sentences, one or more sets of linked sentences; wherein each set of the one or more sets comprises sentences that are linked to each other by one or more sentence linking elements, wherein a sentence linking element comprises at least one out of a verb flow, a noun flow, and an endophora; and
calculating a sentiment of sentences of a set of the one or more sets, wherein the calculating of a sentiment of a certain sentence of the set is based on, at least, a sentiment of at least one other sentence of the set.

2. The non-transitory computer readable medium according to claim 11 wherein the calculating of the sentiment of the certain sentence is also responsive to an initial sentiment of the certain sentence calculated based on the content of the certain sentence.

3. The non-transitory computer readable medium according to claim 12 wherein the initial sentiment of the certain sentence is inert.

4. The non-transitory computer readable medium according to claim 11 wherein the sentence linking element comprises at least two out of the verb flow, the noun flow, and the endophora.

5. The non-transitory computer readable medium according to claim 11 wherein the sentence linking element comprises at least one out of the noun flow, and the endophora.

6. The non-transitory computer readable medium according to claim 11 wherein the calculating of the sentiment of the certain sentence of the set of the one or more sets is based on, at least, sentiments of all other sentences of the set.

7. The non-transitory computer readable medium according to claim 11 wherein the calculating of the sentiment of the certain sentence of the set of the one or more sets is based on, at least, a weighted sum of sentiments of all other sentences of the set.

8. The non-transitory computer readable medium according to claim 11 that stores instructions for calculating sentiments of all sentences of at least one of the one or more sets.

9. The non-transitory computer readable medium according to claim 11 that stores instructions for calculating sentiments of all sentences of each set of the one or more sets.

10. The non-transitory computer readable medium according to claim 11 wherein the calculating of the sentiment of the certain sentence of the set of the one or more sets comprising selecting a sentiment of one of the sentences of the set.

11. A non-transitory computer readable medium for determining sentiments of sentences of a group of sentences, the non-transitory computer readable medium stores instructions for:
obtaining the group of sentences;
finding, within the group of sentences, one or more sets of linked sentences; wherein each set of the one or more sets comprises sentences that are linked to each other by one or more sentence linking elements, wherein a sentence linking element comprises at least one out of a verb flow, a noun flow, and an endophora; and
calculating a sentiment of a certain sentence of a set of the one or more sets based on, at least, a sentiment of at least one other sentence of the set.

12. The non-transitory computer readable medium according to claim 11 wherein the calculating of the sentiment of the certain sentence is also responsive to an initial sentiment of the certain sentence calculated based on the content of the certain sentence.

13. The non-transitory computer readable medium according to claim 12 wherein the initial sentiment of the certain sentence is inert.

14. The non-transitory computer readable medium according to claim 11 wherein the sentence linking element comprises at least two out of the verb flow, the noun flow, and the endophora.

15. The non-transitory computer readable medium according to claim 11 wherein the sentence linking element comprises at least one out of the noun flow, and the endophora.

16. The non-transitory computer readable medium according to claim 11 wherein the calculating of the sentiment of the certain sentence of the set of the one or more sets is based on, at least, sentiments of all other sentences of the set.

17. The non-transitory computer readable medium according to claim 11 wherein the calculating of the sentiment of the certain sentence of the set of the one or more sets is based on, at least, a weighted sum of sentiments of all other sentences of the set.

18. The non-transitory computer readable medium according to claim 11 that stores instructions for calculating sentiments of all sentences of at least one of the one or more sets.

19. The non-transitory computer readable medium according to claim 11 that stores instructions for calculating sentiments of all sentences of each set of the one or more sets.

20. The non-transitory computer readable medium according to claim 11 wherein the calculating of the sentiment of the certain sentence of the set of the one or more sets comprising selecting a sentiment of one of the sentences of the set.
